(19) United States
(12) Patent Application Publication
(10) Pub. No.: US 2006/0191196 A1
(43) Pub. Date: Aug. 31, 2006

(54) Planter and a planter assembly

(76) Inventor: Bradley Cochran, Royal Oak, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/068,412

(22) Filed: Feb. 28, 2005

(51) Int. Cl. A01G 9/02

(52) U.S. Cl. 47/66.1

(57) ABSTRACT

Several planters 10, 200, 300, and 400 which may be utilized in an “above ground” or “in ground” application and which allow complex geometric shapes to be made in an aesthetically pleasing overall appearance.

### FIELD OF THE INVENTION

The present invention generally relates to a planter and more particularly, to a planter and a planter assembly which is adapted to operatively and selectively receive plants (or other selectively growable materials) and to allow these plants to grow while being further adapted to be selectively and operatively deployed within or above the ground as part of an overall planting assembly and to form complex geometric patterns in an aesthetically pleasing manner.

### BACKGROUND OF THE INVENTION

A planter or a planter assembly is typically used to receive plants and to allow the received plants (or other vegetation) to grow. While these planters do allow the received entities to generally grow, they are not generally adapted to be efficiently used to create complex and sophisticated designs or geometric arrangements which are greatly desired by landscape architects, homeowners, commercial building owners, and others. Further, most of these planters and planter assemblies are only adapted to be used in an above ground manner, thereby further limiting their overall utility and being susceptible to being readily stolen, moved, or “turned over” and providing a generally less pleasing overall aesthetic appearance than “in ground” type planters and assemblies. These planters and planter assemblies are also not adapted to allow “mass” plantings to be efficiently accomplished. Moreover, while “in-ground” planters and planter assemblies do exist, they have the further limitation of requiring a great deal of time and effort to deploy and not being readily adaptable to creating complex designs, shapes, and geometric configurations.

There is therefore a need for a new and improved planting assembly which overcomes the various previously delineated drawbacks and limitations which are associated with current and prior planting assemblies and planters. The present invention overcomes these and other drawbacks and limitations in a new and novel manner.

### SUMMARY OF THE INVENTION

It is a first non-limiting object of the present invention to provide a planter and a planting assembly which overcomes some or all of the previously delineated drawbacks and disadvantages of the prior planters and planting assemblies.

It is a second non-limiting object of the present invention to provide a planter and a planting assembly which overcomes some or all of the previously delineated drawbacks and disadvantages of the prior planters and planting assemblies and which, by way of example and without limitation, may be selectively deployed as part of a complex geometric shape or design.

It is a third non-limiting object of the present invention to provide a planter and a planting assembly which overcomes some or all of the previously delineated drawbacks and disadvantages of prior planters and planting assemblies and which, by way of example and without limitation, by operatively deployed in an “above-ground” or “in ground” application.

According to a first non-limiting aspect of the present invention, a planter assembly is provided and includes a planter having a body which forms a trough between a pair of open ends and which further includes at least two pair of dimples; and a member which is selectively received in the at least two pair of dimples and which, when received in the at least two pair of simples, closes one of the pair of open ends of the body.

According to a second non-limiting aspect of the present invention, a planter having a bottom portion and two substantially identical side portions which each terminate along a respective and opposed edge of the bottom portion and which cooperate with said bottom portion to form a trough, is provided. Particularly, the bottom portion includes a substantially “C” shaped portion which is longitudinally coextensive to and which protrudes into the formed trough and wherein each of the sidewalls forms a substantially similar and obtuse angle with respect to the bottom portion and respectively include generally flat ledge portions which respectively emanate from the pair of side portions and wherein each of the pair of side portions further respectively including a first and a second dimple, wherein the respective first and the second dimples of each of the side portions are operatively and respectively disposed along a respective axis which is substantially perpendicular to the pair of flat ledge portions; and an insert which is adapted to be selectively and removably fitted within the trough while concomitantly being received in the first and second dimples of each of the side portions and having a portion receives the substantially “C” shaped portion of the bottom portion.

According to a third non-limiting aspect of the present invention, a planter is provided and includes a first and second opposed wall portions which are dissimilar in length and substantially parallel to each other; third and fourth wall portions which respectively terminate within the first and second wall portions and which cooperate with the first and second wall portions to form a storage space, wherein the third wall forming a right angle with each of the first and second opposed wall portions and wherein the fourth wall forming a respective oblique angle with each of the first and second wall, portions; and a bottom portion which terminates upon the first, second, third, and fourth wall portions.

According to a fourth non-limiting aspect of the present invention, a planter is provided and includes a polygonal-shaped body having a generally flat ledge portion which, outwardly protrudes from and which terminates upon the body and wherein the ledge portion includes a plurality of holes and at least two opposed dimples; and a plurality of fasteners which are each adapted to be selectively and frictionally received within each of the holes.

According to a fifth non-limiting aspect of the present invention, a planter assembly, is provided and includes a planter having a generally cylindrical body which forms a cavity, wherein the body includes a ledge portion which protrudes from the body and which substantially circumvents the formed cavity and wherein the ledge includes two raised and substantially “C” shaped handle portions; and a container having a containment cavity and an internal ledge which is configured to abuttingly receive the ledge portion of said planter, thereby allowing the planter to be selectively and operatively received within the container in order to selectively form a planter assembly.

These and other features, aspects, and advantages of the present invention are further delineated in the following detailed description of the preferred embodiment of the invention, including the subjoined claims, and by reference to the following drawings.

### BRIEF DESCRIPTION OF THE DRAWINGS

FIG. 1 is an unassembled perspective view of a planter which is made in accordance with the teachings of a first embodiment of the present invention,

FIG. 2 is a sectional view of the planter which is shown in FIG. 1;

FIG. 3 is a perspective view of a planter which is made in accordance with the teachings of a second embodiment of the invention;

FIG. 4 is a sectional view of the planter which is shown in FIG. 3;

FIG. 5 is a perspective unassembled view of a planter which is made in accordance with the teachings of a third embodiment of the invention;

FIG. 6 is a sectional view of the planter which is shown in FIG. 5;

FIG. 7 is a perspective view of a planter which is made in accordance with the teachings of a fourth embodiment of the invention;

FIG. 8 is a sectional view of the planter which is shown in FIG. 7;

FIG. 9 is a perspective view of a receptacle which is made in accordance with the teachings of a fifth embodiment of the invention;

FIG. 10 is a sectional view of the receptacle which is shown in FIG. 9; and

FIG. 11 is an unassembled view of a planting assembly which is made in accordance with the teachings of a sixth embodiment of the invention.

### DETAILED DESCRIPTION OF THE PREFERRED EMBODIMENT OF THE INVENTION

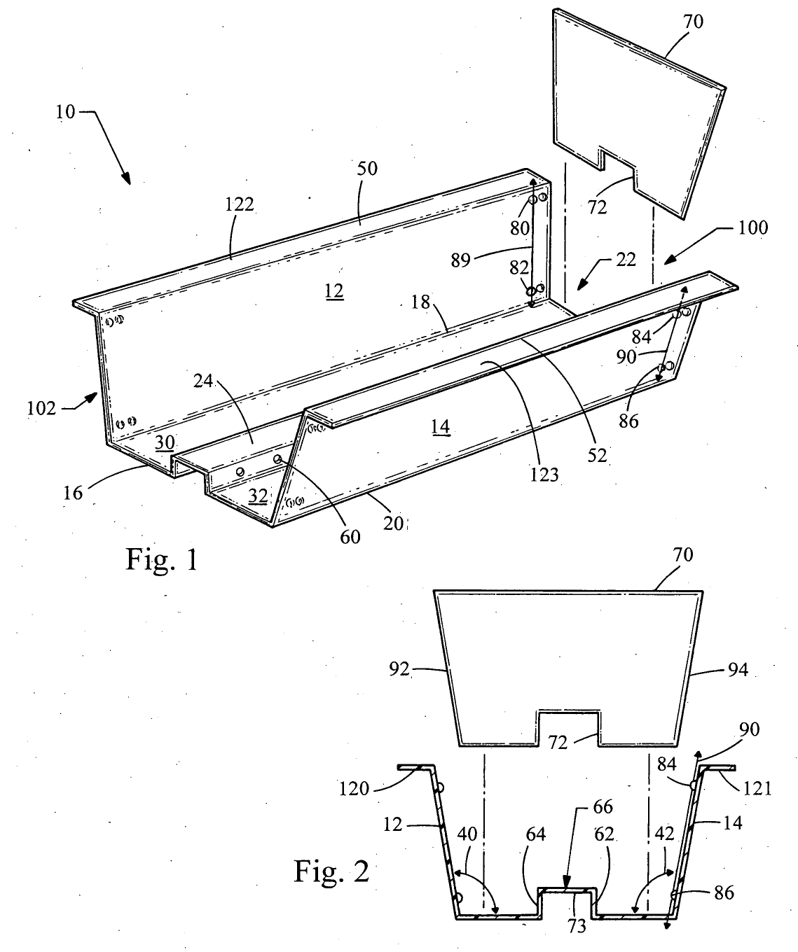

Referring now to FIGS. 1-2, there is shown a planter 10 which is made in accordance with the teachings of a first non-limiting embodiment of the present inventions.

Particularly, the planter 10 includes a pair of opposed wall portions 12, 14 and a base member or portion 16 having two opposed edges 18, 20 upon which the opposed wall portions 12, 14 respectively terminate. In one non- limiting embodiment of the invention, the wall portions 12, 14 and base member or portion 16 are part of the same apparatus 10 (e.g., the wall portions 12, 14 and the base portion 16 are integrally formed with the apparatus 10).

In one non-limiting embodiment of the invention, the side walls 12, 14 and the bottom portion 16 cooperate to form a trough portion 22 which may be used to operatively receive plants or other “growable” entities (e.g., other forms of vegetation). Further, in one non-limiting embodiment of the invention, the bottom portion 16 includes a substantially “C”-shaped protruding portion 24 which extends into and which protrudes into the formed trough 22 and-which is linearly coextensive to the walls 12, 14 and to the edges 18, 20 and which further resides in the “middle” of the bottom portion 16 (e.g., the portion 24 “cuts” the bottom portion 16 into two distinct, substantially identical, and symmetrical regions or portions 30, 32).

Further, as shown, in one non-limiting embodiment of the invention, the sidewall portions 12, 14 respectively form oblique angles (e.g., non-right angles) 40, 42 with respect the base portion 16 and each of the sidewall portions 12, 14 respectively terminates into or forms a respective and substantially identical generally flat ledge 50, 52 which are linearly coextensive to the edges 18, 20 and which protrude away from the formed trough 16 and away from the planter 10. A plurality of substantially identical venting or drainage holes 60 may be formed on each of the opposed sides 62, 64 of the portion 24 and the top surface 66, of the portion 24, is substantially parallel to each of the ledges 50, 52 and is made to be relatively smooth.

The planter 10 may be used with an element 70 having an insertion portion 72 having a substantially “C” shaped or recessed portion which is complementary to the substantially “C” shape of the portion 24. That is, the portion 72 is adapted to fittingly engage and frictionally, removably, and selectively receive the portion 24. Further, the each of the sidewall portions 12, 14 include at least a pair of respective dimples 80, 82 and 84, 86. Particularly, the dimples 80, 82 are operatively aligned along an axis 89 which intersects the edge 18 while the dimples 84, 86 are operatively aligned along an axis 90 which intersects the edge 20.

Thus, when the portion 24 is received within the portion 72, the edge 92 of the portion 70 is removably received within the dimples 80, 82 and the edge 94 of the portion 70 is removably received within the dimples 84, 86. In this manner, the portion or element 70 may selectively close or “block” the open end 100 of the planter 10 and the formed trough 22. A substantially similar dimple arrangement may be deployed on the portions of the side walls 12, 14 proximate to the opposed open end 102. In this manner, two such members 70 may selectively and removably close the formed trough 22, thereby forming a “closed typed” planter which may be used in an “above ground” application.

It should be appreciated that a plurality of planters 10 may be selectively and easily stacked for storage by placing a trough 22 of a first planter 10 within a trough 22 of a second planter and continuing stacking the plurality of planters 10 in this manner, always placing the trough portion 22 of a new planter 10 into the trough portion 22 of the most recently stacked planter 22. 10. Further, it should be realized that a first planter 10 may have its side walls 12, 14 placed into the ground but leaving its trough portion 22 exposed. A second planter 10 may have its trough portion 22 receive plants or other vegetation or other selectively growable material and then placed within the trough portion 22 of the first planter 10 which had been previously placed in the ground in the foregoing manner. Thus, new plants and growable material may quite easily placed and removed from a certain area in an efficient and cost effective manner which allows for efficient mass plantings and the planters 10 may be selectively arranged in complex geometric formations. The drainage holes 60 of a trough portion 22 cooperatively allow water and other liquid material which may be communicated to the trough portion 22 to “flow” or be moved away from the trough portion 22, thereby substantially reducing the likelihood of root rot or other undesirable conditions associated with the contained and selectively growable material. Moreover, the placement of the drainage holes on the surfaces 62, 64 reduces the liklihood that the holes 62, 64 will be blocked by sediment, roots, or other material.

It should further be appreciated that in other non- limiting embodiments of the invention, a first planter 10 may have its trough portion 22 communicatively coupled to a trough portion 22 of at least one other such planter 10, thereby forming an extended trough portion 22. Particularly, the underside 73 of the portion 24 of a second planter 10 is placed upon surface 66 of a first planter 10, through the first open end 100 of the first planter 10, and the respective underside portions 120, 121 of the ledges 50, 52 of the second planter are respectively placed upon the respective top portions 122, 123 of the ledges 50, 52 of the first planter 10. A third planter 10 may similarly be coupled to the first planter 10 through the second open end 102 of the first planter 10. Similarly, the second and third planters 10 may have their respective trough portions 22 communicatively coupled to the trough portion 22 of the first planter 10 and, in this manner, a plurality of planters 10 may be coupled in a manner which allows a substantially long trough portion 22 to be created and which allows a planter assembly to be formed. After the extended trough portion is created, an element 70 is coupled to the respectively exposed and open end 100,102 of each of the planters 10 which are coupled to only another single planter 10. In this manner, the planters 10 may be used to form a substantially long single planting assembly and the formed assembly may be submerged into the ground in the manner delineated above and the single formed trough 22 may receive other planters 10 in the manner delineated above white basis selectively closed by a pair of members 70.

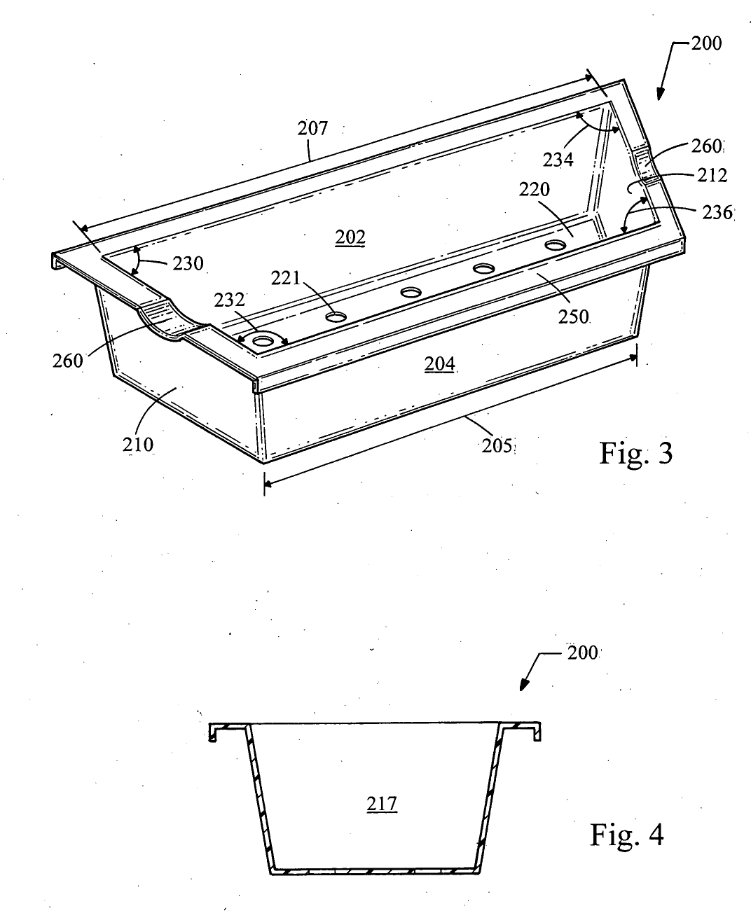

Referring now to FIGS. 3 and 4, there is shown a planter 200 which is made in accordance with the teachings of a second and non-limiting embodiment of the invention.

Particularly, the planter 200 includes substantially planar wall portions 202, 204 which are substantially parallel to each other and which have a dissimilar length (e.g., length 205 of portion 204 is purposefully made shorter than length 207 of portion 202). Further, the planter 200 includes planar walls 210, 212 which each respectively terminate into the walls 202, 204 and which cooperate with the walls 202, 204 to form a containment cavity 217. The planter 200 further includes a generally planar bottom portion 220 which includes several substantially identical drainage holes 221. Further, wall portion 210 forms respective oblique angles 230, 232 with respective wall portions 202, 204 and wall portion 212 respectively forms oblique angles 234, 236 with respective wall portions 202, 204. In one non-limiting embodiment of the invention, each of the wall portions 202, 204, 210, and 212 and bottom portion 220 are integrally formed with the planter 200.

Further, in one non-limiting embodiment of the invention, each of the wall portions 202, 204, 210, and 212 include a flange or ledge and when the wall portions 202, 204, 210, and 212 are formed or coupled to form the planter 200, the ledges cooperatively form a continuous ledge 250 which substantially circumvents the cavity. 217 and protrudes away from cavity 217. In an “integral formation” manufacturing process, the ledge 250 is formed as a single continuing ledge. Further, the portion of the ledge 250 which is formed on the wall portions 210 and 212 includes a dimple 260 and these dimples 260 allow an individual to readily carry the planter 200 (e.g., the dimples 260 are located on the pair of two opposed walls 210, 212 which are not directly coupled). It should be appreciated that a greater or lesser amount of dimples 260 may be utilized and formed on the ledge 250.

It should be appreciated that vegetation or selectively growable material may be placed within the cavity 217 and the drainage holes 221 allow water and other liquid materials to be readily removed or to flow away from the cavity 217. It should be appreciated that the planter 200 may be selectively submerged into the ground (e.g., the wall portions 202, 204, 210, and 212 are submerged into the ground leaving the cavity 217 exposed. A second planter 200 may be selectively placed into the exposed cavity 217 (e.g., the bottom portion 220 of this second planter 200 may be placed within the cavity 217), thereby allowing the planter 200 to be used in an “in ground” or “above ground” situation. It should also be appreciated that the planters 200 may be efficiently and cooperatively form complex geometric patterns.

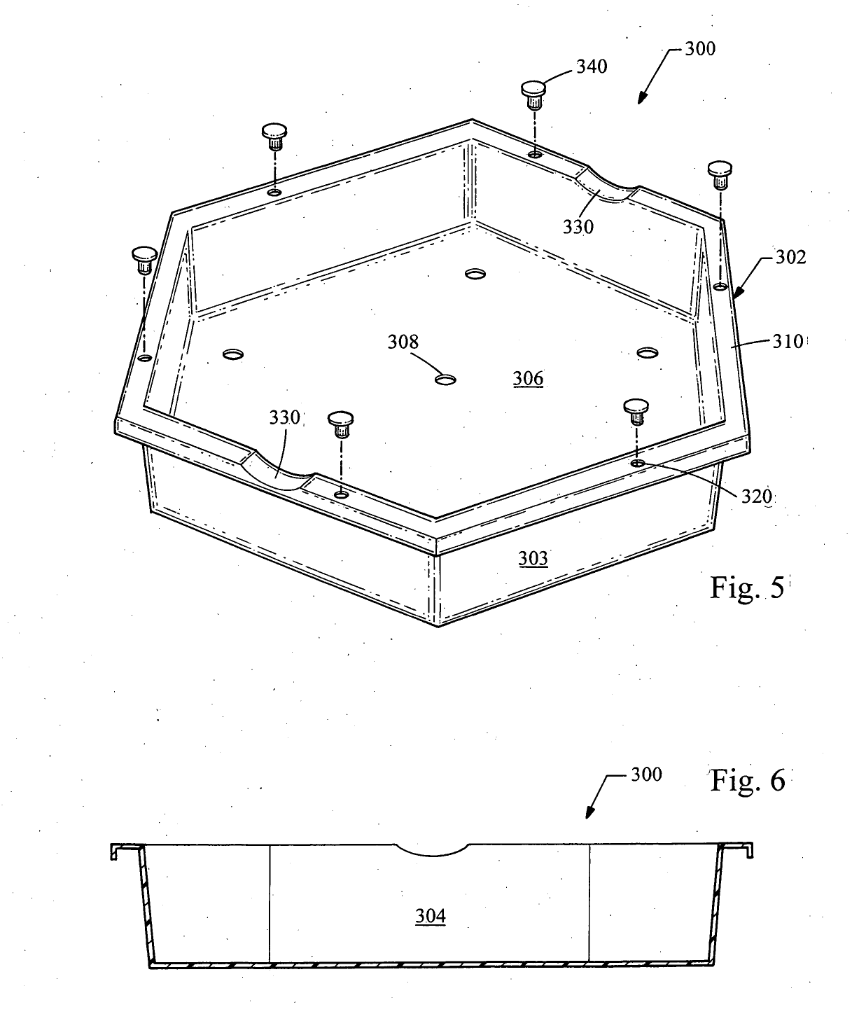

Referring now to FIGS. 5 and 6, there is shown a planter 300 which is made in accordance with the teachings of a third embodiment of the invention.

Particularly, the planter 300 includes a polygonal shaped body 302 (e.g., a body which is formed in the shape of a hexagon) having a depression or cavity 304 which, in one limiting embodiment of the invention, is formed in the same shape as the body 302. The body 302 includes side walls 303, a solid and generally planter bottom portion 306 which terminates within or is integrally formed with the walls 303, and a generally flat ledge 310 which is integrally formed with the walls 303 and which substantially circumvents the depression or cavity 304, which protrudes away from the body 302, and which includes a plurality of substantially identical and equally spaced holes 320. Further, the ledge 310 includes at least two dimples or depressions 330 which may be used to allow the planter 300 to be carried by a user and the bottom portion 306 includes a plurality of substantially identical drainage holes 308.

It should be appreciated that the planter 300 may be used in an “above ground” application or a first of the planters 300 may be submerged into the ground by having body 302 submerged with the depression 306 exposed. A second planter 300 may then be placed within the depression 306, thereby forming an “in ground” planter assembly.

In yet another non-limiting embodiment of the invention, a plurality of fasteners 340 are provided and each of these fasteners 340 are adapted to be selectively placed within and frictionally but removably fit within the holes 320 and such fasteners 340 may comprise pins, screws, or some other conventional fastener.

Particularly, in one non-limiting embodiment of the invention, the planters 300 may be selectively arranged and coupled in a manner which provides for complex and aesthetically pleasing geometric patterns. That is, the portion of the ledge 310 located above a wall 303 of a first planter 300 may overlay the portion of the ledge 310 located above a wall 303 of a second planter 300 and the two coupled portions of ledges 310 may be secured by a fastener 320 which may be inserted into each of the two ledges, thereby coupling the two planters 300 together. In this manner, other ledges may be secured and several of the planters 300 may be secured in a manner which allows a selective geometric pattern to be formed.

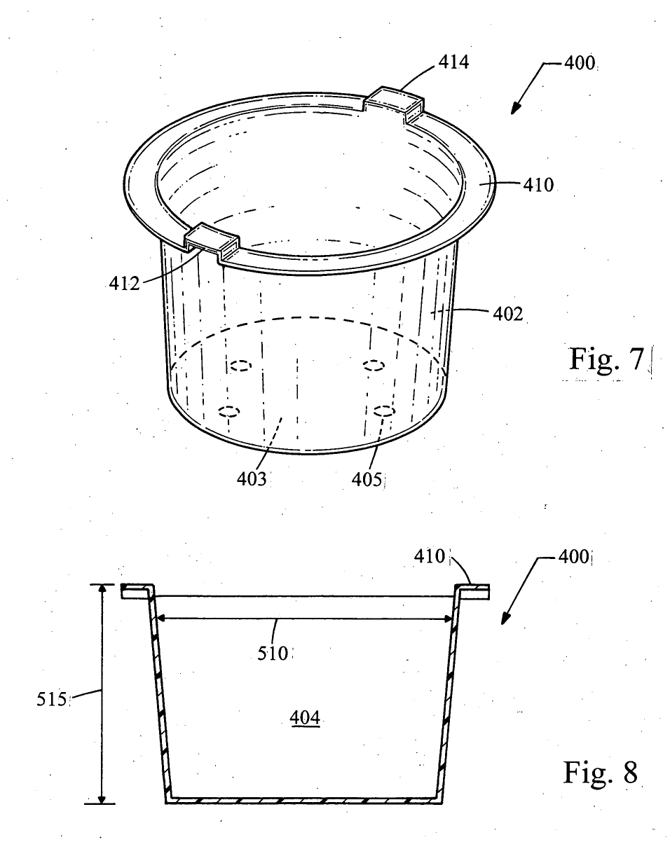

Referring now to FIGS. 7-8, there is shown a planter 400, which is made in accordance with the teachings of a fourth embodiment of the invention and which includes a generally cylindrical body 402 having a generally flat bottom portion 403 which includes a plurality of substantially identical drainage holes 405. The body 402 is generally hollow and forms an internal reception cavity 404. Further, the body 402 includes a ledge portion 410 which outwardly extends or protrudes from the body portion 402 and which includes two substantially similar and substantially “C” shaped raised protuberances or portions 412,414 which facilitate the carrying or the transport of the planter 400. It should be realized that the planter 400 may be used in an “above ground” application or be selectively submerged into the ground in a manner which allows the cavity 404 to be exposed. The exposed cavity 404 may then selectively receive another such planter 400, thereby securing the received second planter in an operative planting position. It should be further appreciated that a greater or lesser number of portions 412 may be formed on the ledge 410.

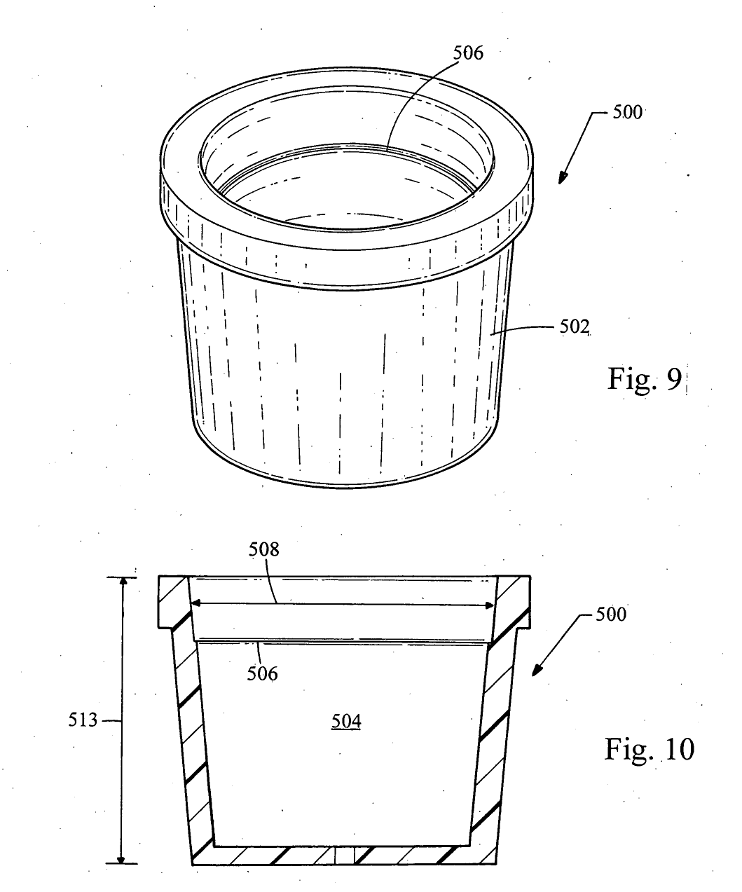

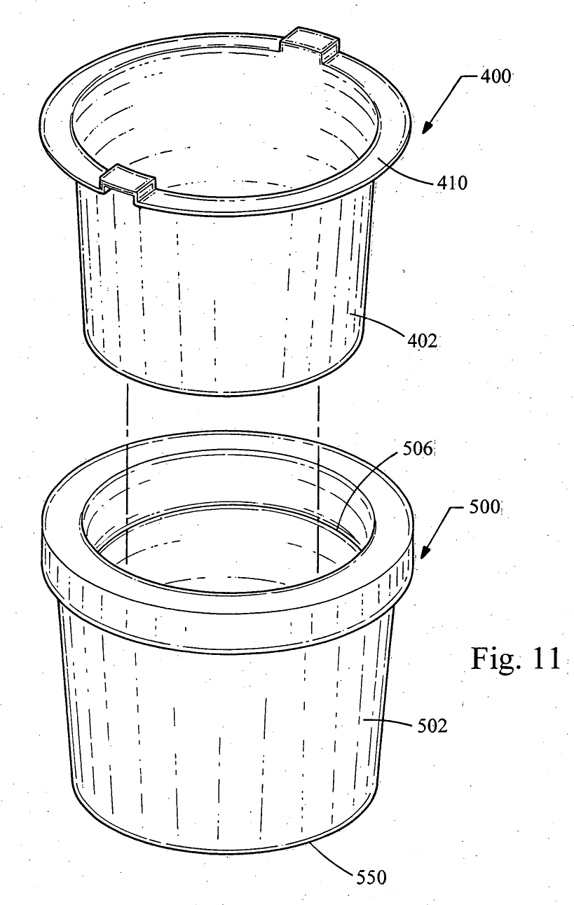

Referring now to FIGS. 9-11, there is shown a planting receptacle 500 which includes a generally cylindrical body 502 and an open cavity 504. The open cavity 504 includes at least one internal lip or ledge 506 which extends around the circumference of the internal cavity 504, and a bottom portion 550. In the most preferred embodiment of the invention, the diameter 508 of the planting receptacle 500 is larger than the diameter 510 of the planter 400 and the height 513 of the receptacle 500 is larger than the height 515 of the planter 400. In this manner, as shown best in FIG. 11, the body 402 of a planter 400 may be selectively inserted within the receptacle 500 and the ledge 410 may rest upon the internal lip or ledge 506, thereby allowing the planter to be operatively placed within the receptacle 500 and readily allowing water to be drained from the planter 400 (e.g., the bottom portion 403 is elevated with respect to the bottom portion 550).

It is to be understood that the foregoing inventions are not limited to the exact construction or methodology which has been delineated above, but that various changes and modifications may be made without departing from the spirit and the scope of the inventions as are more fully delineated in the following claims. Further, it should be realized that the foregoing planter embodiments may each be used in an “above ground” or an “in ground” application and that each of them may be respectively used to efficiently form complex geometric and aesthetically pleasing shapes and may efficiently allow “mass” growings (e.g., growings over a large area) to be efficiently accomplished. It should be appreciated that Applicant has found that an “in ground” planting or “container gardening” arrangement allows for a dramatic decrease in the amount of water needed to be applied to the plants and eliminate and/or substantially reduces the likelihood of “transplant shock”) from occurring since the plants are grown within a container and the entire container is placed in the “in ground” receptacle without the need to remove the previously grown plants. Further, interconnecting container substantially eliminates or dramatically reduces the likelihood of weed growth (e.g., weed germination) between the interconnected containers since such interconnections overlay the ground between the containers, and substantially eliminates or dramatically reduces the likelihood of weed growth within a container since sterile soil may be used within a container, each growing season.

What is claimed is:

1) A planter assembly including a planter having a body which forms a trough between a pair of open ends and which further includes at least two pair of dimples; and a member which is selectively received in said at least two pair of dimples and which, when received in said at least two pair of dimples, closes one of said pair of open ends of said body.

2) The planter assembly of claim 1 wherein each of said pair of dimples are located on opposed sides of said one of said pair of open ends.

3) The planter assembly of claim 2 wherein body further includes a protruding portion and wherein said member includes a recess which receives said protruding member when said member is received into said at least two pair of dimples.

4) A planter having a bottom portion and two substantially identical side portions which each terminate along a respective and opposed edge of said bottom portion and which cooperate with said bottom portion to form a trough, wherein said bottom portion having a substantially “C” shaped portion which is longitudinally coextensive to and which protrudes into said formed trough and wherein each of said sidewalls forms a substantially similar and obtuse angle with respect to said bottom portion and respectively include generally flat ledge portions which respectively emanate from said pair of side portions and wherein each of said pair of side portions further respectively including a first and a second dimple, wherein said respective first and said second dimples of each of said side portions are operatively and respectively disposed along a respective axis which is substantially perpendicular to said pair of flat ledge portions; and an insert which is adapted to be selectively and removably fitted within said trough while concomitantly being received in said first and second dimples of each of said side portions and having a portion receives said substantially “C” shaped portion of said bottom portion.

5) The planter of claim 4 wherein said substantially “C” shaped raise portion includes a plurality of drainage holes which are disposed above said bottom portion.

6) A planter comprising a first and second opposed wall portions which are dissimilar in length and substantially parallel to each other; third and fourth wall portions which respectively terminate within said first and second wall portions and which cooperate with said first and second wall portions to form a storage space, wherein said third wall forming a right angle with each of said first and second opposed wall portions and wherein said fourth wall forming a respective oblique angle with each of said first and second wall portions; and a bottom portion which terminates upon said first, second, third, and fourth wall portions.

7) The planter of claim 6 wherein said bottom portion includes a plurality of drainage holes.

8) The planter of claim 7 further comprising a ledge portion which is substantially parallel to said bottom portion and which terminated upon each of said wall portions while circumventing said storage space.

9) The planter of claim 8 wherein said ledge portion includes two opposed dimples.

10) A planter comprising a polygonal shaped body having a generally flat ledge portion which outwardly protrudes from and which terminates upon said body and wherein said ledge portion includes a plurality of holes and at least two opposed dimples; and a plurality of fasteners which are each adapted to be selectively and frictionally received within each of said holes.

11) The planter of claim 10 wherein said polygonal shape forms a hexagon.

12) The-planter of claim 10 wherein each of said plurality of fasteners are substantially identical.

13) The planter of claim 12 wherein-each of said plurality of fasteners comprises a pin.

14) The planter of claim 10 wherein said body forms a recess cavity-having a plurality of drainage holes.

15) The planter of claim 14 wherein said recess cavity terminates into a flat bottom portion.

16) A planter assembly comprising a planter having a generally cylindrical body which forms a cavity, wherein said body includes a ledge portion which protrudes from said body and which substantially circumvents said formed cavity and wherein said ledge includes two raised “C” shaped handle portions; and a container having a containment cavity and an internal ledge which is configured to abuttingly receive said ledge portion of said planter, thereby allowing said planter to be selectively and operatively received within said container.

17) The planter assembly of claim 16 wherein the height of said planter is less than the height of said container.

18) The planter assembly of claim 17 wherein the width of said planter is less than the width of said container.

19) The planter assembly of claim 18 wherein said two raised “C” shaped handle portions are substantially identical.
